(19) United States
(12) Patent Application Publication
(10) Pub. No.: US 2025/0223395 A1
(43) Pub. Date: Jul. 10, 2025

(54) NCO-Terminated Prepolymer for Coating Applications

(71) Applicant: Covestro Deutschland AG, Leverkusen (DE)

(72) Inventors: Florian Golling, Dortmund (DE); Laura Woods, Köln (DE); Hans-Josef Laas, Odenthal (DE)

(21) Appl. No.: 18/846,908

(22) PCT Filed: Mar. 15, 2023
(86) PCT No.: PCT/EP2023/056627

§ 371 Date: Sep. 13, 2024

(30) Foreign Application Priority Data
Mar. 16, 2022 (EP) 22162432.3

(51) Int. Cl. C08G 18/10; C08G 18/24; C08G 18/42; C08G 18/62; C09D 175/04; C09J 175/04

(52) U.S. Cl. CPC C08G 18/10; C08G 18/244; C08G 18/4219; C08G 18/6229; C09D 175/04; C09J 175/04

(57) ABSTRACT

The present disclosure relates to a NCO-terminated prepolymer for coating applications, to a process for preparing the inventive NCO-terminated prepolymer and to the use of the inventive NCO-terminated prepolymer. The present disclosure further relates to a two-component-system, including a component A), including at least the inventive NCO-terminated prepolymer and a component B), including at least one compound which includes at least one Zerewitinoff-active group. Additionally, the present disclosure relates to a process for curing a composition on a substrate and to the cured article.

### CROSS-REFERENCE TO RELATED APPLICATIONS

This application is the United States national phase of International Patent Application No. PCT/EP2023/056627 filed Mar. 15, 2023, and claims priority to European Patent Application No. 22162432.3 filed Mar. 16, 2022, the disclosures of which are hereby incorporated by reference in their entireties.

### BACKGROUND

### Technical Field

The present invention relates to a NCO-terminated prepolymer for coating applications, to a process for preparing the inventive NCO-terminated prepolymer and to the use of the inventive NCO-terminated prepolymer. The present invention further relates to a two-component-system, comprising a component A), comprising at least the inventive NCO-terminated prepolymer and a component B), comprising at least one compound which comprises at least one Zerewitinoff-active group. Additionally, the present invention relates to a process for curing a composition on a substrate and to the cured article.

### Description of Related Art

It is known that NCO-terminated prepolymers can be used as curing components in polyurethane coating or coating systems. These prepolymers are generally obtained by reacting polyols with di- or polyisocyanates. As a curing component, the prepolymers then react in the coating or coating system with further polyols, for example with polyacrylate polyols, to give the corresponding polyurethanes. Depending on the desired application, e.g. original equipment manufacturer (OEM) coating processes or manual coating application in the refinish sector, the requirements to the applied coating compositions can vary tremendously.

WO 2016/116376 A1 describes isocyanate-functional polyester prepolymers from a combination of branched polyesters and caprolactone polyesters having a low viscosity while being crystallization stable at temperatures above 5° C. and a high elasticity. However, these prepolymers do not produce suitable coatings when cured with commercially available standard polyols. In particular, these formulations do not dry and have limited solvent resistance.

### SUMMARY

Therefore, it was an object of the present invention to provide a NCO-terminated prepolymer which enables formulation of curable compositions with standard commercially available polyols as binders while maintaining excellent physical and chemical properties of the obtained coatings.

It has been surprisingly found by the present inventors that following aspects of the present invention can overcome the above-mentioned deficiencies:

The present invention relates to a NCO-terminated prepolymer for, preferably manual, coating applications having the general formula (I),

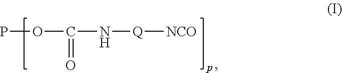

wherein P, Q and p are defined as follows
P each independently at least one organic radical obtained by removing the hydroxyl groups from a polyol unit,
Q each independently at least one organic radical obtained by removing the isocyanate groups from a monomeric diisocyanate unit and/or at least one organic radical obtained by removing the isocyanate groups from an uretdione unit having two isocyanate groups and
p each independently a number of ≥2.0, and
wherein the NCO-terminated prepolymer has
a NCO content of ≥6.5 to ≤12.0% by weight, based on total solid content of the NCO-terminated prepolymer, and
a content of ≤17% by weight of oligomers having a number average molecular weight ≤1000 g/mol, based on the total solid content of the NCO-terminated prepolymer, and
a monomeric diisocyanate content of <0.5% by weight, based on the total solid content of the NCO-terminated prepolymer and
a polydispersity of ≥2.0.

### DETAILED DESCRIPTION

In the present invention, any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In the context of the present invention, “unit” means that the structural unit present in the general formula (I) is derived from the reactive compounds described below. For example, when a diisocyanate is converted with a diol or polyol, one isocyanate group and one hydroxy group form a urethane group. However, the remaining compounds used, such as the six methyl groups of hexamethylene diisocyanate, remain unchanged. “Unit” in the present invention is thus understood to mean both the parts of the compounds that are not involved in the reaction and the functional groups, such as a hydroxy group or isocyanate group, which undergo the reaction forming the urethane group shown in general formula (I). In the context of the present invention, the corresponding unit is always derived from the compounds used in the synthesis.

“Each independently” means, in the context of the present invention, that if the corresponding unit is multiple in the general formula (I), the units are equal or different and selected from the group of possible units. According to the present invention, it is also possible that there is a mixture of compounds of the general formula (I), with different possible units present in the individual molecules.

The inventive prepolymer having the general formula (I) is NCO-terminated. In the present invention the term “NCO-terminated” means that the functional end groups that are present are essentially isocyanate groups. The term “essentially” in this regard means that preferably at least 80 mol %, more preferably at least 90 mol % and most preferred ≥99 to 100 mol % of the functional end groups present in the NCO-terminated prepolymer are isocyanate groups, also named herein as NCO groups.

In the present invention the term “polymer” refers to a compound, formed during a chemical reaction by linking several monomers (i.e. more than two monomers) of the same or different kind together via covalent bonding, wherein the resulting polymer can differ in its degree of polymerization, molecular weight distribution and chain length respectively. Hence, a polymer according to the present invention is a compound, comprising in its molecular structure at least one repeating unit, which was integrated in the polymer structure during polymer synthesis by repeatedly linking monomers together via covalent bonds to form said polymer structure.

The term “polymer” includes homopolymers, copolymers, block-copolymers and oligomers.

In the present invention, a “prepolymer” is a polymer with reactive groups. In analogy to the definition of the term “polymer”, the molecular structure of a prepolymer is formed by repeatedly linking more than two monomers of the same or different kind together. The prepolymer can participate in a subsequent formation of a polymer, which has a higher molecular weight than said prepolymer. The term “prepolymer” encompasses polymers, which are able to chemically react via at least one of its reactive groups, forming a repeating unit of a (preferably crosslinked) polymer. Therefore the term “prepolymer” encompasses as well self-crosslinking polymers with at least two different kinds of reactive groups, wherein said groups are able to chemically react among themselves, so that the prepolymer molecules are able to crosslink. The number average molecular weight is preferably at least 900 g/mol, more preferably at least 1,000 g/mol.

According to this invention, if not otherwise specified, the average molecular weight is defined as the number average molecular weight Mn. As molecular weight of polymers the number average molecular weight Mn is applied. Mn is determined via gel permeation chromatography (GPC) at 23° C. in tetrahydrofuran as the solvent. The measurement is performed as described in DIN 55672-1:2016-03 “Gelpermeationschromatographie, Teil 1—Tetrahydrofuran als Elutionsmittel”.

According to this invention, the content of oligomers having a number average molecular weight ≤1000 g/mol is determined with before mentioned GPC method. The proportion is taken from the chromatograms in area %, which were determined with software support, and is equated approximately in proportions in weight %.

The content of monomeric diisocyanate is determined according to DIN EN ISO 10283:2007-11 by gas chromatography using an internal standard and is preferably <0.3% by weight, based on the total solid content of the NCO-terminated prepolymer.

The NCO contents were determined by titrimetry as per DIN EN ISO 11909:2007-05.

According to this invention, the polydispersity is determined according to DIN 55672-1:2016-03.

An “organic compound” contains at least one moiety, comprising a carbon-hydrogen covalent bond.

According to this invention, the term “aliphatic” is defined as non-aromatic hydrocarbyl groups being saturated or unsaturated.

According to this invention, the term “araliphatic” is defined as hydrocarbyl moieties composed of a non-aromatic, as well as saturated or unsaturated hydrocarbyl group, which is directly bonded to an aromatic moiety.

According to this invention, the term “alicyclic” or “cycloaliphatic” are optionally substituted, carbocyclic or heterocyclic compounds or moieties, which are non-aromatic (like for example cycloalkanes, cycloalkenes or oxa-, thia-, aza- or thiazacycloalkanes). Particular examples are cyclohexyl groups, cyclopentyl groups, and their N- or O-heterocyclic derivatives like for example pyrimidine, pyrazine, tetrahydropyran or tetrahydrofuran.

According to this invention, the term “polyol unit P” can comprise other intramolecular functional groups like e.g. urethane groups. Independent of these intramolecular functional groups which may optionally be present, all “polyol unit P” fulfill the definition of the general formula (I) of the present invention. These intramolecular functional groups might be formed e.g. by possible chain extension during prepolymer synthesis.

According to this invention, the NCO-terminated prepolymer having the general formula (I) contains urethane groups as intramolecular functional groups and essentially does not comprise other functional groups derived from NCO-groups, like e.g. isocyanurate groups. “Essentially” in this regard means, that other functional groups besides urethane groups are only contained in a very minor amount, which for example might be unavoidable during synthesis. Preferably such other functional groups are only present in an amount of ≤5 mol %, more preferably ≤2 mol % and most preferred ≤0.5 mol % based on the amount of urethane groups of the NCO-terminated prepolymer. Same definition and preferred embodiments applies for the NCO-terminated prepolymer obtained or obtainable by the inventive process.

The mol % contents of the urethane groups in general formula (I) and essentially not contained beforementioned other intramolecular functional groups, e.g. “isocyanurate groups”, are calculated from the integrals of proton-decoupled ¹³C-NMR spectra. In the case of NCO-terminated prepolymers based on 1,6-diisocyanatohexane (HDI) dissolved in CDCl₃, the individual structural elements have the following chemical shifts (in ppm): isocyanurate: 148.4 and urethane: 156.3.

In a first preferred embodiment, the inventive NCO-terminated prepolymer having the general formula (I) is characterized in that the content of oligomers having a number average molecular weight ≤1000 g/mol is ≥0.5 to ≤17% by weight, preferably ≥1.0 to ≤14% by weight and most preferably ≥1.5 to ≤10% by weight, based on the total solid content of the NCO-terminated prepolymer. This has the advantage that the solvent and chemical resistance of the cured composition is further increased.

In a preferred embodiment, the inventive NCO-terminated prepolymer having the general formula (I) is characterized in that the NCO terminated prepolymer has an NCO content of ≥7.5 to ≤11.0% by weight. This has the advantage that the hardness of the coating is still sufficient while minimizing the number of reactive groups.

In principle, the inventive NCO-terminated prepolymer having the general formula (I) can have any molecular weight known to the person skilled in the art. In a preferred embodiment, the inventive NCO-terminated prepolymer having the general formula (I) is characterized in that the NCO-terminated prepolymer has a number average molecular weight Mn≥1700 g/mol, preferably ≥1700 to ≤3500 g/mol, more preferably ≥1700 to ≤3100 g/mol. The average molecular weight Mn is determined as mentioned before.

In a preferred embodiment, the inventive NCO-terminated prepolymer having the general formula (I) is characterized in that the NCO-terminated prepolymer has an average NCO functionality of >2.0, preferably of >2.7. The functionality is calculated using the following formular:

$$F = \frac{\sum ( val excess component ) - \sum ( val limited component )}{\sum ( mol excess component + mol limited component ) - \sum ( val limited component )}$$

Typically, the unit Q in the inventive NCO-terminated prepolymer having the general formula (I) is at least one aliphatic, cycloaliphatic, araliphatic and/or aromatic radical obtained by removing the isocyanate groups from a monomeric diisocyanate unit and/or at least one organic radical obtained by removing the isocyanate groups from an uretdione unit having two isocyanate groups.

Suitable monomeric diisocyanates OCN-Q-NCO have aliphatically, cycloaliphatically, araliphatically and/or aromatically bound isocyanate groups. The monomeric diisocyanates can be prepared by any desired process, for example by phosgenation or by phosgene-free route, for example by urethane cleavage.

For example, these monomeric diisocyanates, also referred to below as starting diisocyanates, are those having a molecular weight range of 168 to 400 g/mol, such as, for example, 1,4-butandiisocyanate, 1,5-diisocyanatopentane (PDI), 1,5-diisocyanato-2,2-dimethyl-pentane, 1,6-diisocyanatohexane (HDI), 2,2,4- or 2,4,4-trimethyl-1,6-diisocyanatohexane, 1,8-diisocyanatooctane, 1,9-diisocyanato-nonane, 1,10-diisocyanatodecane, 1,3- and 1,4-diisocyanatan ocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4 (3)-isocyanatomethylcyclohexane, 2,4′- and 4,4′-diisocyanatodicyclohexylmethane (H12-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclo-hexylmethane, 4,4′-diisocyanato-1,1′-bi (cyclohexyl), 4,4′-diisocyanato-3,3′-dimethyl-1,1′-bi (cyclohexyl), 4,4′-diisocyanato-2,2′,5,5′-tetra-methyl-1,1′-bi (cyclohexyl), 1,8-diisocyanato-p-methane, 1,3-diisocyanatoadamantane, 1,3-dimethyl-5,7-diisocyanatoadamantane, 1,3- and 1,4-bis(isocyanatomethyl)benzene (XDI), 1,3- and 1,4-bis(1-isocyanato-1-methylethyl)benzene (TMXDI), bis(4-(1-isocyanato-1-methylethyl)phenyl) carbonate, 1,3-phenylene diisocyanate, 1,4-phenylene diisocyanate, 2,4- and 2,6-toluylene diisocyanate and any mixtures of these isomers, diphenylmethane-2,4′- and/or -4,4′-diisocyanate and naphthylene-1,5-diisocyanate and any mixtures of such diisocyanates. Other diisocyanates which are also suitable are also found, for example, in Justus Liebig's Annalen der Chemie, 562, 1949, 75-136.

In addition or as an alternative, OCN-Q-NCO is at least one uretdione polyisocyanate having two isocyanate groups.

Suitable uretdione units having two isocyanate groups are typically obtained by dimerization, optionally in the presence of a catalyst, of the monomeric diisocyanates mentioned herein or polyisocyanates thereof by methods, which are known in the art. Examples of optional dimerization catalysts are: trialkylphosphines, aminophosphines and aminopyridines such as dimethylaminopyridines, and tris(dimethylamino)phosphine, as well as any other dimerization catalyst known to those skilled in the art. The result of the dimerization reaction depends, in a manner known to the skilled person, on the catalyst used, on the process conditions and on the diisocyanates employed. In particular, it is possible for products to be formed, which contain on average more than one uretdione group per molecule, the number of uretdione groups being subject to a distribution. The uretdione unit preferably on average contains from 1 to 10 uretdione groups. Preferred uretdione units are prepared from the catalytic dimerization of PDI, HDI and/or IPDI.

In a preferred embodiment, the inventive NCO-terminated prepolymer having the general formula (I) is characterized in that Q is independently at least one an aliphatic and/or cycloaliphatic radical obtained by removing the isocyanate groups from a diisocyanate, preferably selected from the group consisting of 1,5-diisocyanatopentane, 1,6-diisocyanatohexane, isophorone diisocyanate, 2,4′- and 4,4′-diisocyanatodicyclohexylmethane 1,3- and 1,4-bis-isocyanatomethylcyclohexane, 1,3- and 1,4-xylylene diisocyanate and mixtures selected from the beforementioned, more preferably selected from the group consisting of 1,5-diisocyanatopentane, 1,6-diisocyanatohexane and/or isophorone diisocyanate.

In general, the unit P in the inventive NCO-terminated prepolymer having the general formula (I) is at least one organic radical obtained by removing the hydroxyl groups from a polyol, preferably selected from the group consisting of polyether polyols, polyester polyols, polyurethane polyols, polysiloxane polyols, polycarbonate polyols, polybutadiene polyols, polyacrylate polyols, polymethacrylate polyols, copolymers of polyacrylate polyols and polymethacrylate polyols and mixtures thereof, more preferably selected from the group consisting of polyether polyols, polyester polyols, polyurethane polyols, polysiloxane polyols, polyacrylate polyols and mixtures thereof. In principle, these polyols are known to the person skilled in the art.

Polyester polyols P(OH)ₚ are obtained in a manner known per se by reacting polyhydric alcohols, for example those mentioned above with from 2 to 14 carbon atoms, with substoichiometric amounts of polycarboxylic acids, corresponding carboxylic acid anhydrides, corresponding polycarboxylic acid anhydrides lower alcohols or lactones.

The acids or acid derivatives used for the preparation of the polyester polyols may be aliphatic, cycloaliphatic and/or aromatic and may be optionally substituted and/or unsaturated, for example by halogen atoms. Examples of suitable acids are polybasic carboxylic acids having a molecular weight of 118 to 300 g/mol or derivatives thereof, such as succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, dimethyl terephthalate and bis-glycol terephthalic acid esters.

Any desired mixtures of these starting compounds mentioned by way of example may also be used for the preparation of the polyester polyols.

A type of polyester polyols which is preferably to be used as a polyol unit P are those which can be prepared in a manner known per se from lactones and simple polyhydric alcohols, such as, for example, those mentioned above by way of example, as starter molecules under ring opening. Examples of suitable lactones for preparing these polyester polyols are β-propiolactone, γ-butyrolactone, δ-valerolactone, ε-caprolactone, 3,5,5- and 3,3,5-trimethylcaprolactone or any mixtures of such lactones.

Polyhydroxyl compounds of the polycarbonate type which are suitable as polyol P(OH)ₚ are, in particular, the polycarbonate polyols known per se, such as can be prepared, for example, by reacting dihydric alcohols, for example those mentioned above in the list of polyhydric alcohols having a molecular weight range of 62 to 400 g/mol, with diaryl carbonates, such as, for example, diphenyl carbonate, dialkyl carbonates, such as, for example, dimethyl carbonate, or phosgene.

Polyhydroxyl compounds of the polyester carbonate type which are suitable as polyol P(OH)ₚ are, in particular, the diols which contain ester groups and carbonate groups and are known per se, as can be obtained, for example, in accordance with the teaching of DE-A 1 770 245 or WO 03/002630 by reacting dihydric alcohols with lactones of the type mentioned above by way of example, in particular ε-caprolactone, and subsequently reacting the resulting polyester diols with diphenyl carbonate or dimethyl carbonate.

Polyether polyols suitable as polyol P(OH)ₚ are, in particular, those having an average molecular weight, which can be calculated from functionality and hydroxyl number, of from 800 to 3000 g/mol, preferably from 900 to 2000 g/mol, more preferably of 900 to 1500 g/mol, as are obtainable in a manner known per se by alkoxylation of suitable starter molecules. To prepare these polyether polyols, any desired polyhydric alcohols, such as the simple polyhydric alcohols having 2 to 14 carbon atoms described above, can be used as starter molecules. Alkyl oxides suitable for the alkoxylation reaction are, in particular, ethylene oxide and propylene oxide, which can be used in any desired sequence or else in a mixture in the alkoxylation reaction.

Suitable polyether polyols P(OH)ₚ are also the polyoxytetramethylene glycols known per se, by polymerization of tetrahydrofuran.

Suitable polyester polyols P(OH)ₚ can also be prepared by polycondensation of aliphatic dicarboxylic acids and/or anhydrides thereof with excess amounts of polyfunctional alcohols and has a number-average molecular weight of 800 to 3000 g/mol, preferably of 900 to 2000 g/mol, more preferably of 900 to 1500 g/mol, where the polyfunctional alcohols are branched aliphatic diols to an extent of at least 30% by weight, based on the total amount of polyfunctional alcohols used.

Polyester polyols of this kind are known. They are prepared in a manner known per se by methods as described, for example, Gubbels, E. et al., 2018, Polyesters. In: Ullmann's Encyclopedia of Industrial Chemistry: Wiley-VCH Verlag & GmbH Co. KGaA, URL: https://doi.org/10.1002/14356007.a21_227.pub2 . . . . If necessary, catalytic amounts of standard esterification catalysts, for example acids, bases or transition metal compounds, for example titanium tetrabutoxide, may be used. The esterification reaction is generally conducted within a temperature range from about 80 to 260° C., preferably from 100 to 230° C., until the desired values for the hydroxyl and acid numbers have been attained.

Starting compounds for preparation of the polyester polyols are any desired linear aliphatic or cycloaliphatic, saturated or unsaturated dicarboxylic acids or the anhydrides thereof having 4 to 12 carbon atoms, preferably having 4 to 6 carbon atoms, and polyhydric aliphatic or cycloaliphatic alcohols, preferably diols and triols, having 2 to 18 carbon atoms, preferably 2 to 6 carbon atoms.

Suitable dicarboxylic acids or anhydrides for preparation of the polyester polyols are, for example, succinic acid, succinic anhydride, glutaric acid, adipic acid, pimelic acid, suberic acid, azelaic acid, sebacic acid, decanedicarboxylic acid, maleic acid, maleic anhydride, fumaric acid, itaconic acid, itaconic anhydride, hexahydrophthalic acid, hexahydrophthalic anhydride, tetrahydrophthalic acid and tetrahydrophthalic anhydride, which can be used either individually or in the form of any desired mixtures with one another.

Suitable polyfunctional alcohols for preparation of the polyester polyols are, for example, ethane-1,2-diol, propane-1,3-diol, butane-1,4-diol, pentane-1,5-diol, hexane-1,6-diol, heptane-1,7-diol, octane-1,8-diol, nonane-1,9-diol, decane-1,10-diol, dodecane-1,12-diol, cyclohexane-1,2-and-1,4-diol, cyclohexane-1,4-dimethanol, 4,4′-(1-methylethylidene)biscyclohexanol, propane-1,2,3-triol (glycerol), 1,1,1-trimethylolethane, hexane-1,2,6-triol, 1,1,1-trimethylolpropane, 2,2-bis(hydroxymethyl)propane-1,3-diol, low molecular weight polyether diols, for example diethylene glycol and dipropylene glycol, and branched aliphatic diols, for example propane-1,2-diol, butane-1,3-diol, 2-methylpropanediol, 2,2-dimethyl-1,3-propanediol (neopentyl glycol), hexane-1,2-diol, 2-methylpentane-2,4-diol, 3-methylpentane-1,5-diol, 2-ethylhexane-1,3-diol, octane-1,2-diol, 2,2,4-trimethylpentane-1,5-diol, 2-butyl-2-ethylpropane-1,3-diol, 2,2,4- and/or 2,4,4-trimethylhexanediol, decane-1,2-diol or any desired mixtures of such alcohols. According to the invention, the polyfunctional alcohols are branched aliphatic diols of the type mentioned to an extent of at least 30% by weight, preferably at least 35% by weight, more preferably at least 40% by weight, based on the total amount of polyfunctional alcohols used.

Starter molecules used for the ring-opening polymerization may, for example, be di- or trifunctional alcohols mentioned above by way of example as suitable starting compounds for preparation of the other suitable polyester polyols or any desired mixtures of these alcohols.

The preparation of the &-caprolactone polyester polyols by ring-opening polymerization is generally effected in the presence of catalysts, for example Lewis or Brønsted acids, organic tin or titanium compounds, at temperatures of 20 to 200° C., preferably 50 to 200° C.

Preferred polyester polyols are those which have been prepared using butane-1,4-diol, diethylene glycol, neopentyl glycol, hexane-1,6-diol, glycerol and/or 1,1,1-trimethylolpropane as starter molecule.

In a preferred embodiment, the inventive NCO-terminated prepolymer having the general formula (I) is characterized in that P in general formula (I) is each independently at least one organic radical obtained by removing the hydroxyl groups from a polyol having an average molecular weight of ≥800 g/mol to ≤3000 g/mol and a OH-functionality of >2 to ≤3, preferably of ≥900 g/mol to ≤2000 g/mol and a OH-functionality of >2 to ≤3 and more preferably of ≥900 g/mol to ≤1500 g/mol and a OH-functionality of >2 to ≤3. Further preferred is that P in general formula (I) is each independently at least one polyol unit having an average molecular weight of ≥800 g/mol to ≤3000 g/mol and a OH-functionality of >2 to <3, preferably of ≥900 g/mol to ≤2000 g/mol and a OH-functionality of >2 to <3 and more preferably of ≥900 g/mol to ≤1500 g/mol and a OH-functionality of >2 to <3.

Even further preferred is that P in general formula (I) is at least one organic radical obtained by removing the hydroxyl groups from a polyester polyol having an average molecular weight of ≥800 g/mol to ≤3000 g/mol and a OH-functionality of >2 to ≤3, preferably of ≥900 g/mol to ≤2000 g/mol and a OH-functionality of >2 to ≤3 and more preferably of ≥900 g/mol to ≤1500 g/mol and a OH-functionality of >2 to ≤3.

In a preferred embodiment, the inventive NCO-terminated prepolymer having the general formula (I) is characterized in that p is each independently a number of ≥2 to <4.5, preferably >2 to <3.

In principle, the inventive NCO-terminated prepolymer can contain or be diluted with a solvent inert towards isocyanate groups but this is not necessary. Suitable solvents are, for example, ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, more highly substituted aromatics, of the kind available commercially, for example, under the names Solventnaphtha, Solvesso®, Isopar®, Nappar®, Varsol® (ExxonMobil Chemical Central Europe, Cologne, Germany) and Shellsol® (Shell Deutschland Oil GmbH, Hamburg, Germany), and also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

The invention further relates to a process for preparing the inventive NCO-terminated prepolymer having the general formula (I), comprising the following steps
a) addition of at least one polyol having an hydroxyl group functionality of ≥2 to <3 and a polydispersity of ≥1.5 to a heated excess of at least one monomeric diisocyanate and/or at least one uretdione having two isocyanate groups in a ratio of NCO:OH groups 4:1 to 20:1 to form urethane groups.
b) removal of the excess of the monomeric diisocyanate by distillation down to <0.5% by weight, preferably down to <0.3% by weight and more preferably down to <0.1% by weight, based on the total solid content of the NCO-terminated prepolymer, to obtain the NCO-terminated prepolymer, and
c) optionally addition of at least one solvent inert towards isocyanate groups.
   The at least one polyol and the at least one monomeric diisocyanate and/or at least one uretdione having two isocyanate groups used in the inventive process follow the same definitions and preferred embodiments outlined above in the description and claims of the inventive NCO-terminated prepolymer unless the context does clearly show the opposite.

The polydispersity of the polyols to be applied in the inventive process can be measured according to DIN 55672-1:2016-03.

The at least one monomeric diisocyanate and/or at least one uretdione having two isocyanate groups is preferably reacted with the at least one polyol at temperatures of 20 to 200° C., preferably 40 to 160° C., more preferably 60 to 140° C.

In a preferred embodiment of the inventive process the at least one polyol has an average molecular weight of ≥800 to ≤3000 g/mol, preferably of ≥900 to ≤2000 g/mol and most preferably of ≥900 to ≤1500. This has the advantage that the content of oligomers having a number average molecular weight ≤1000 g/mol in the inventive NCO-terminated prepolymer can be further reduced to ≤17% by weight, more preferably ≥0.5 to ≤17% by weight, even more preferably ≥1.0 to ≤14% by weight and most preferably ≥1.5 to ≤ 10% by weight, based on the total solid content of the NCO-terminated prepolymer.

In general, it is possible to either use directly a polyol having already such a defined minimum average molecular weight or, if the polyol which should be used possess a lower average molecular weight, it is possible to purify it, preferably in a distillation step, before the addition in step a) to increase the average molecular weight to the values mentioned in the foregoing paragraph.

It is alternatively or additionally preferred to conduct the step b) of the inventive process at temperatures higher than needed for removal of the excess of the monomeric diisocyanate in order to further reduce the content of oligomers having a number average molecular weight ≤1000 g/mol to ≤17% by weight, more preferably ≥0.5 to ≤17% by weight, even more preferably ≥1.0 to ≤14% by weight and most preferably ≥1.5 to ≤10% by weight, based on the total solid content of the NCO-terminated prepolymer. The beforementioned higher temperatures are dependent on the type of monomer being removed and can be determined by the skilled person by simple experiments without undue burden, for example by taking the thin film evaporation temperature of the monomeric diisocyanate, which shall be removed, and increasing this temperature by at least 10° C. but not higher than 200° C.

The process of the invention can be conducted without catalysis. If necessary, however, suitable catalysts can also be used to accelerate the urethanization reaction. These are the conventional catalysts known from polyurethane chemistry, for example tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl-/N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,8-diazabicyclo[5.4.0]undec-7-ene (DBU), 1,2-dimethylimidazole, 2-methylimidazole, N,N-dimethylimidazole-β-phenylethylamine, 1,4-diazabicyclo[2.2.2]octane, bis(N,N-dimethylaminoethyl) adipate; alkanolamine compounds, for example triethanolamine, triisopropanolamine, N-methyl- and N-ethyldiethanolamine, dimethylaminoethanol, 2-(N,N-dimethylaminoethoxy) ethanol, N,N′,N″-tris(dialkylaminoalkyl)hexahydrotriazines, for example N,N′,N″-tris(dimethylaminopropyl)-s-hexahydrotriazine and/or bis(dimethylaminoethyl) ether; metal salts, for example inorganic and/or organic compounds of iron, lead, bismuth, zinc and/or tin in customary oxidation states of the metal, for example iron (II) chloride, iron (III) chloride, bismuth (III) bismuth (III) 2-ethylhexanoate, bismuth (III) octoate, bismuth (III) neodecanoate, zinc chloride, zinc 2-ethylcaproate, tin (II) octoate, tin (II) ethylcaproate, tin (II) palmitate, dibutyltin (IV) dilaurate (DBTL), dibutyltin (IV) dichloride or lead octoate; amidines, for example 2,3-dimethyl-3,4,5,6-tetrahydropyrimidine; tetraalkylammonium hydroxides, for example tetramethylammonium hydroxide; alkali metal hydroxides, for example sodium hydroxide, and alkali metal alkoxides, for example sodium methoxide and potassium isopropoxide, and also alkali metal salts of long-chain fatty acids having 10 to 20 carbon atoms and optionally lateral OH groups.

These catalysts are used in the process of the invention, if at all, preferably in an amount of 0.001 to 5% by weight, more preferably 0.005 to 1% by weight, based on the total weight of all co-reactants, and may be added either before the beginning of the reaction or at any time during the reaction.

The progress of the reaction in the process of the invention can be monitored by determining the NCO content by titrimetric means, for example as per DIN EN ISO 11909:2007-05. On attainment of the desired NCO content, preferably when the NCO content corresponding in theoretical terms to complete conversion of isocyanate and hydroxyl groups has been attained in the reaction mixture, any urethanization catalysts used are preferably deactivated by addition of suitable catalyst poisons.

Such catalyst poisons are, for example, inorganic acids such as hydrochloric acid, phosphorous acid or phosphoric acid, acid chlorides such as acetyl chloride, benzoyl chloride or isophthaloyl chloride, sulfonic acids and sulfonic esters, such as methanesulfonic acid, p-toluenesulfonic acid, trifluoromethanesulfonic acid, perfluorobutanesulfonic acid, dodecylbenzenesulfonic acid, methyl and ethyl p-toluenesulfonate, mono- and dialkyl phosphates such as monotridecyl phosphate, dibutyl phosphate and dioctyl phosphate, but also silylated acids such as trimethylsilyl methanesulfonate, trimethylsilyl trifluoromethanesulfonate, tris(trimethylsilyl) phosphate and diethyl trimethylsilyl phosphate.

The amount of catalyst poison required for deactivation of the catalyst is guided by the amount of the catalyst used. In general, an equivalent amount of the catalyst poison is used, based on the urethanization catalyst used at the start. If, however, any catalyst losses that occur during the reaction are taken into account, even 20 to 80 equivalent % of the catalyst poison, based on the amount of catalyst originally used, may be sufficient to stop the reaction.

The process of the invention is preferably conducted without solvent. If desired, however, suitable solvents inert toward the reactive groups of the starting components can also be used. Suitable solvents are, for example, the customary paint solvents that are known per se such as ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, more highly substituted aromatics, of the kind available commercially, for example, under the names Solventnaphtha, Solvesso®, Isopar®, Nappar®, Varsol® (ExxonMobil Chemical Central Europe, Cologne, Germany) and Shellsol® (Shell Deutschland Oil GmbH, Hamburg, Germany), and also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

Independent of the optional use of a solvent in step a) or b) the inventive process comprise the optional step c) of addition of at least one solvent inert towards isocyanate groups to reach a preferred viscosity of <2000 mPas at 23° C. measured to DIN EN ISO 3219:1994-10. Such optional solvent is preferably selected from the beforementioned list. In case step c) is conducted, a suitable solvent is preferably added in an amount to achieve a solids content of >50% by weight, more preferably a solids content of >80% by weight and most preferred a solids content of >95% by weight.

The invention further pertains to a NCO-terminated prepolymer for, preferably manual, coating applications having the general formula (I),

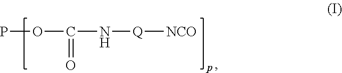

wherein P, Q and p are defined as follows
P each independently at least one organic radical obtained by removing the hydroxyl groups from a polyol unit,
Q each independently at least one organic radical obtained by removing the isocyanate groups from a monomeric diisocyanate unit and/or at least one organic radical obtained by removing the isocyanate groups from an uretdione unit having two isocyanate groups and
p each independently a number of ≥2.0, and
wherein the NCO-terminated prepolymer has
a NCO content of ≥6.5 to ≤12.0% by weight, based on total solid content of the NCO-terminated prepolymer, and
a content of ≤17% by weight of oligomers having a number average molecular weight ≤1000 g/mol, based on the total solid content of the NCO-terminated prepolymer, and
a monomeric diisocyanate content of <0.5% by weight, based on the total solid content of the NCO-terminated prepolymer and
wherein P does not comprise a mixture of
   at least one polyester polyol unit A) of mean functionality from 1.9 to 2.3 and of number-average molecular weight from 300 to 3000 g/mol, prepared from aliphatic dicarboxylic acids and/or anhydrides thereof with excess amounts of polyfunctional alcohols, where the polyfunctional alcohols are branched aliphatic diols to an extent of at least 30% by weight, based on the total amount of polyfunctional alcohols, and
   at least one polycaprolactone polyester unit B) of mean functionality from 2.0 to 3.0 and number-average molecular weight from 176 to 2000 g/mol,
wherein the polyester unit A) in the total amount of polyester units A) and B) is from 15% to 70% by weight in the NCO terminated prepolymer.

For this aspect it is further preferred that P does not comprise polycaprolactone polyester units of mean functionality from 2.0 to 3.0 and number-average molecular weight from 176 to 2000 g/mol.

All embodiments and preferences disclosed herein for the other aspects of the invention can be combined with the beforementioned two aspects, with the exception that suitable polyols P(OH)ₚ are selected from the disclosed components in a way that the mixture of polyester units A) and B) is disclaimed and the exception that the polydispersity of the inventive NCO-terminated prepolymer can be below 2.0, but is preferably also ≥2.0.

Thus, the invention further relates to a process for preparing the inventive NCO-terminated prepolymer having the general formula (I), comprising the following steps
a) addition of at least one polyol having an hydroxyl group functionality of ≥2 to <3 to a heated excess of at least one monomeric diisocyanate and/or at least one uretdione having two isocyanate groups in a ratio of NCO:OH groups 4:1 to 20:1 to form urethane groups,
b) removal of the excess of the monomeric diisocyanate by distillation down to <0.5% by weight, preferably down to <0.3% by weight and more preferably down to <0.1% by weight, based on the total solid content of the NCO-terminated prepolymer, to obtain the NCO-terminated prepolymer, and
c) optionally addition of at least one solvent,
wherein the at least one polyol does not comprise a mixture of
   at least one polyester polyol unit A) of mean functionality from 1.9 to 2.3 and of number-average molecular weight from 300 to 3000 g/mol, prepared from aliphatic dicarboxylic acids and/or anhydrides thereof with excess amounts of polyfunctional alcohols, where the polyfunctional alcohols are branched aliphatic diols to an extent of at least 30% by weight, based on the total amount of polyfunctional alcohols, and
   at least one polycaprolactone polyester unit B) of mean functionality from 2.0 to 3.0 and number-average molecular weight from 176 to 2000 g/mol,
   wherein the polyester unit A) in the total amount of polyester units A) and B) is from 15% to 70% by weight in the NCO terminated prepolymer.

For this process it is further preferred that the at least one polyol does not comprise polycaprolactone polyester units of mean functionality from 2.0 to 3.0 and number-average molecular weight from 176 to 2000 g/mol at all.

The at least one polyol and the at least one monomeric diisocyanate and/or at least one uretdione having two isocyanate groups used in the inventive process follow the same definitions and preferred embodiments outlined above in the description, the aspects and claims of the inventive NCO-terminated prepolymer unless the context does clearly show the opposite.

Because of the special physico-chemical properties of the inventive NCO-terminated prepolymer, it is especially suitable for a use in curable compositions for coatings, adhesives and/or sealants, which is a further aspect of the present invention.

The invention further pertains to a two-component-system, comprising or consisting of a component A), comprising at least one inventive NCO-terminated prepolymer, and a component B), comprising at least one compound which comprises at least one Zerewitinoff-active group.

Suitable compounds which comprise at least one Zerewitinoff-active group are, for example, the conventional polymeric polyether polyols, polyester polyols, polycarbonate polyols and/or polyacrylate polyols known from polyurethane chemistry, which usually have a number-average molecular weight of from 200 to 22,000, preferably from 250 to 18,000, particularly preferably from 250 to 12,000. A broad overview of suitable polymeric polyols can be found, for example, in N. Adam et al.: “Polyurethanes”, Ullmann's Encyclopedia of Industrial Chemistry, Electronic Release, 7th ed., chap. 3.2-3.4, Wiley-VCH, Weinheim 2005.

As an alternative to the abovementioned hydroxy-functional compounds, polyamines, such as, for example, the polyaspartic acid derivatives known from EP-B 0 403 921, or also those polyamines whose amino groups are present in blocked form, such as, for example, polyketimines, polyaldimines or oxazolanes, are also suitable as isocyanate-reactive binders. Free amino groups are formed from these blocked amino groups under the influence of moisture and, in the case of the oxazolanes, also free hydroxyl groups which react with crosslinking with the isocyanate groups of the polyisocyanate.

In a preferred embodiment, the at least one compound, which comprises at least one Zerewitinoff-active group, is selected from polyester polyols, polyether polyols, polyurethane polyols, polyacrylate polyols, polymethacrylate polyols, polycarbonate polyols and mixtures thereof.

In another preferred embodiment, said component B) comprises less than 5% by weight, preferably less than 2% by weight, more preferably less than 1% by weight of solvent. This has the advantage to further improve the economic and working safety properties because the volatile organic emissions are significantly reduced without negatively affecting the performance of the inventive two-component-systems. Suitable solvents can be selected from the commonly used solvents for such two-component-systems and are for example selected from the list described above for the inventive NCO-terminated prepolymer and the inventive process.

If appropriate, further auxiliaries and additives customary in the coating sector can be added to the spraying system. Examples of suitable auxiliaries and additives are leveling auxiliaries, color pigments, filler materials, matting agents, inorganic or organic pigments, light stabilizers, lacquer additives, such as dispersants, leveling agents, thickeners, antifoams and other auxiliaries, adhesives, fungicides, bactericides, stabilizers or inhibitors and catalysts or emulsifiers.

To control the speed of curing, it is possible to use suitable catalysts in the formulation of the coating compositions, for example the urethanization catalysts that are customary in isocyanate chemistry, as already described above, for example, as catalysts for preparation of the NCO-terminated prepolymers of the invention. If catalysts are used in the inventive two-component-system, they are preferably contained in compound B).

In all the uses described above for the inventive NCO-terminated prepolymer, they may be used either alone or, for example to increase the crosslinking density, in blends with any desired further polyisocyanates having aliphatically, cycloaliphatically, araliphatically and/or aromatically bonded isocyanate groups, more particularly with the known paint polyisocyanates having uretdione, isocyanurate, iminooxadiazinedione, urethane, allophanate, biuret and/or oxadiazinetrione structure, as described by way of example in Laas et al., J. Prakt. Chem. 336, 1994, 185-200, DE-A 1 670 666, DE-A 3 700 209, DE-A 3 900 053, EP-A 0 330 966, EP-A 0 336 205, EP-A 0 339 396 and EP-A 0 798 299, as isocyanate component.

In the inventive two-component-system for polyurethane and/or polyurea paints and coatings which comprise the inventive NCO-terminated prepolymer as crosslinker components or constituents of crosslinker components for polyols, polythiols and/or polyamines, the co-reactants are customarily present in amounts such that for every isocyanate group there are 0.5 to 3, preferably 0.6 to 2.0, more preferably 0.8 to 1.6 Zerewitinoff-active groups (also herein referred to as isocyanate-reactive groups).

The invention further relates to a process for curing a composition on a substrate or in a cavity, comprising the following steps
i) applying on at least one substrate or in a cavity at least one inventive two-component-system and
ii) exposing the deposited composition to a temperature of 0 to 120° C., preferably of 20 to 90° C. and more preferred of 20 to 60° C. to cure said deposited curing composition.

It is preferred to mix component A) and component B) of the two-component-system to obtain a mixture just prior to applying the two-component system on at least one substrate or in a cavity meaning that said mixture is preferably applied in step i). Upon curing of the deposited composition, the cured composition forms a solid on the substrate or in the cavity. In case the system is deposited on at least one substrate, such solid is preferably a coating or an adhesive. In case of being an adhesive, it is preferred to add a second substrate in a further step between step i) and ii) or to add such second substrate directly in step i). In case the system is deposited in a cavity, such solid is preferably a sealant or a foam.

Substrates suitable for the coatings, adhesives and/or sealants formulated using the inventive NCO-terminated prepolymers or the inventive two-component-system include any desired substrates, such as, for example, metal, wood, glass, stone, ceramic materials, concrete, rigid and flexible plastics, textiles, leather, and paper, which prior to coating may optionally also be provided with customary primers.

The invention further pertains to a cured article obtainable or obtained by the inventive process for curing a composition on a substrate or in a cavity. In one preferred embodiment, the cured composition is a refinish coating and the substrate is a refinish substrate. In this embodiment, the cured composition is preferably an automotive refinish coating and the substrate is a refinish automotive substrate. In another preferred embodiment, the cured composition is a foam or sealant in a building house.

A further aspect of the present invention is the use of the either the inventive NCO-terminated prepolymer or the inventive two-component-system for coatings, adhesives and/or sealants, especially in automotive repair applications, or for foams and/or sealants, especially in the building industry.

The present invention in particular pertains to the following embodiments:

According to a first aspect, the invention relates to a NCO-terminated prepolymer for coating applications having the general formula (I),

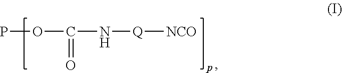

wherein P, Q and p are defined as follows
P each independently at least one organic radical obtained by removing the hydroxyl groups from a polyol unit having an average molecular weight of ≥800 g/mol to ≤3000 g/mol and a OH-functionality of >2 to <3,
Q each independently at least one an aliphatic and/or cycloaliphatic radical obtained by removing the isocyanate groups from a diisocyanate and
p each independently a number of ≥2.0, and
   wherein the NCO-terminated prepolymer has
a NCO content of ≥6.5 to ≤12.0% by weight, based on total solid content of the NCO-terminated prepolymer, and
a content of ≤17% by weight of oligomers having a number average molecular weight ≤1000 g/mol, based on the total solid content of the NCO-terminated prepolymer, and
a monomeric diisocyanate content of <0.5% by weight, based on the total solid content of the NCO-terminated prepolymer and
a polydispersity of ≥2.0.

According to a second aspect, the invention relates to the NCO-terminated prepolymer according to the first aspect, characterized in that the content of oligomers having a number average molecular weight ≤ 1000 g/mol is ≥0.5 to ≤17% by weight, preferably ≥1.0 to ≤14% by weight and most preferably ≥1.5 to ≤10% by weight, based on the total solid content of the NCO-terminated prepolymer.

According to a third aspect, the invention relates to the NCO-terminated prepolymer according to the first or the second aspect, characterized in that the NCO terminated prepolymer has an NCO content of ≥7.5 to ≤11.0% by weight.

According to a fourth aspect, the invention relates to the NCO-terminated prepolymer according to any one of the preceding aspects, characterized in that the NCO-terminated prepolymer has a number average molecular weight Mn≥1700 g/mol, preferably ≥1700 to ≤3500 g/mol, more preferably ≥1700 to ≤3100 g/mol.

According to a fifth aspect, the invention relates to the NCO-terminated prepolymer according to any one of the preceding aspects, characterized in that the NCO-terminated prepolymer has an average NCO functionality of >2.0, preferably of >2.7.

According to a sixth aspect, the invention relates to the NCO-terminated prepolymer according to any one of the preceding aspects, characterized in that Q in general formula (I) is each independently at least one an aliphatic and/or cycloaliphatic radical obtained by removing the isocyanate groups from a diisocyanate selected from the group consisting of 1,5-diisocyanatopentane, 1,6-diisocyanatohexane, isophorone diisocyanate, 2,4′- and 4,4′-diisocyanatodicyclohexylmethane 1,3- and 1,4-bis-isocyanatomethylcyclohexane, 1,3- and 1,4-xylylene diisocyanate and mixtures selected from the beforementioned and preferably selected from the group consisting of 1,5-diisocyanatopentane, 1,6-diisocyanatohexane and/or isophorone diisocyanate.

According to a seventh aspect, the invention relates to the NCO-terminated prepolymer according to any one of the preceding aspects, characterized in that P in general formula (I) is each independently at least one polyol unit having an average molecular weight of ≥900 g/mol to ≤2000 g/mol and a OH-functionality of >2 to <3 and more preferably of ≥900 g/mol to ≤1500 g/mol and a OH-functionality of >2 to <3.

According to an eighth aspect, the invention relates to the NCO-terminated prepolymer according to any one of the aspects one to sixth, characterized in that P in general formula (I) is each independently at least one polyester polyol unit having an average molecular weight of ≥800 g/mol to ≤3000 g/mol and a OH-functionality of >2 to <3, preferably of ≥900 g/mol to ≤2000 g/mol and a OH-functionality of >2 to <3 and more preferably of ≥900 g/mol to ≤1500 g/mol and a OH-functionality of >2 to <3.

According to a ninth aspect, the invention relates to the NCO-terminated prepolymer according to any one of the preceding aspects, characterized in that p in general formula (I) is each independently a number of ≥2 to <4.5, preferably >2 to <3.

According to a tenth aspect, the invention relates to a process for preparing a NCO-terminated prepolymer according to any one of the aspects one to nine, comprising the following steps
a) addition of at least one polyol having an hydroxyl group functionality of ≥2 to <3 and a polydispersity of ≥1.5 to a heated excess of at least one monomeric diisocyanate in a ratio of NCO:OH groups 4:1 to 20:1 to form urethane groups,
b) removal of the excess of the monomeric diisocyanate is removed by distillation down to <0.5% by weight, preferably down to <0.3% by weight and more preferably down to <0.1% by weight, based on the total solid content of the NCO-terminated prepolymer, to obtain the NCO-terminated prepolymer, and
c) optionally addition of at least one solvent inert towards isocyanate groups.

According to an eleventh aspect, the invention relates to the process according to the tenth aspect, characterized in that, the at least one polyol has an average molecular weight of ≥800 to ≤3000 g/mol, preferably of ≥900 to ≤2000 g/mol and more preferably of ≥900 to ≤1500 g/mol.

According to a twelfth aspect, the invention relates to a use of the NCO-terminated prepolymer according to any one of the aspects one to nine or obtained by the process according to the tenth or eleventh aspect in curable compositions for coatings, adhesives and/or sealants.

According to a thirteenth aspect, the invention relates to a two-component-system, comprising a component A), comprising at least one NCO-terminated prepolymer according to any one of the aspects one to nine, and a component B), comprising at least one compound which comprises at least one Zerewitinoff-active group.

According to a fourteenth aspect, the invention relates to the two-component-system according to aspect thirteen, characterized in that said component B) comprises less than 5% by weight, preferably less than 2% by weight, more preferably less than 1% by weight of organic solvent.

According to a fifteenth aspect, the invention relates to a process for curing a composition on a substrate, comprising the following steps
i) applying on at least one substrate at least one two-component-system according to aspect thirteen or fourteen; and
ii) exposing the deposited composition to a temperature of 0 to 120° C., preferably of 20 to 90° C. and more preferred of 20 to 60° C. to cure said deposited curing composition.

According to a sixteenth aspect, the invention relates to a cured article, obtainable or obtained, preferably directly obtained, by the process according to aspect fifteen.

The present invention is illustrated by reference to examples, although these are not to be understood as being limiting.

### EXAMPLES

All percentages are based on weight, unless stated otherwise.

The NCO contents were determined by titrimetry as per DIN EN ISO 11909:2007-05.

The residual monomer contents were measured to DIN EN ISO 10283:2007-11 by gas chromatography with an internal standard.

All the viscosity measurements were made with a Physica MCR 51 rheometer from Anton Paar Germany GmbH (Germany) to DIN EN ISO 3219:1994-10 at a shear rate of 250 s-1.

The number-average molecular weights reported for the starting polyols were each calculated from OH number and OH functionality.

The content of oligomers having a number average molecular weight ≤1000 g/mol is given as the number average molecular weight Mn determined via gel permeation chromatography (GPC at 23° C.) in tetrahydrofuran as the solvent. The measurement is performed as described in DIN 55672-1:2016-03: “Gelpermeationschromatographie, Teil 1—Tetrahydrofuran als Elutionsmittel” (SECurity GPC-System from PSS Polymer Service, flowrate 1.0 ml/min; columns: 2×PSS SDV linear M, 8×300 mm, 5 μm; RID-detector). Samples of polystyrene standards of known molecular weight were used for calibration. The calculation of the number average molecular weight was performed by software. Baseline values and evaluation threshold values were determined according to above referenced DIN 55672-1.

The NCO functionality is calculated using the following formular:

$$F = \frac{\sum ( val excess component ) - \sum ( val limited component )}{\sum ( mol excess component + mol limited component ) - \sum ( val limited component )}$$

The polydispersity is determined according to DIN 55672-1:2016-03.

### Polyols:

### Polyesterpolyol 1:

19.0 parts by weight based on of trimethyolpropane, 13.8 parts by weight of neopentyl glycol, 23.1 parts by weight of 1,3-butane-1,3-diol, and 56.3 parts by weight of isophthalic acid were weighed into a flask and heated gradually to 200° C. at standard pressure while stirring, in the course of which about 12.2 parts by weight of water distilled off. The elimination of water was finished after about 20 hours. The polyester polyol obtained in this way had the following characteristic data:

| OH number | 264 | mg KOH/g |
|---|---|---|
| OH functionality | 2.7 | |
| Acid number | 4.2 | mg KOH/g |
| Polydispersity | 1.9 | |
| Average molecular weight | 988 | g/mol |
| Viscosity (75° C.) | 22400 | mPas |

### Polyesterpolyol 2:

17.2 parts by weight of neopentyl glycol, 13.3 parts by weight of butane-1,4-diol, 17.5 parts by weight of hexane-1,6-diol, 4.4 parts by weight of 2,2,4-trimethylpentane-1,3-diol, 4.4 parts by weight of 2-butyl-2-ethylpropane-1,3-diol and 43.2 parts by weight of adipic acid were weighed into a flask and, in the presence of 25 ppm of tin (II) chloride as catalyst, heated gradually to 200° C. at standard pressure while stirring, in the course of which about 5 parts by weight of water distilled off.

After the elimination of water had ended, over the course of about 4 hours, a vacuum (15 mbar) was gradually applied and the reaction was completed under these conditions within about a further 15 hours. The polyester polyol obtained in this way had the following characteristic data:

| OH number | 260 | mg KOH/g |
|---|---|---|
| OH functionality | 2.0 | |
| Acid number | 0.2 | mg KOH/g |
| Polydispersity | 2.0 | |
| Average molecular weight | 431 | g/mol |
| Viscosity (25° C.) | 810 | mPas |

### Polyesterpolyol 3:

Hexane-1,6-diol-started ε-caprolactone polyester

| OH number | 172 | mg KOH/g |
|---|---|---|
| OH functionality | 2.0 | |
| Acid number | 0.02 | mg KOH/g |
| Polydispersity | 1.3 | |
| Average molecular weight | 650 | g/mol |
| Viscosity (50° C.) | 80 | mPas |

### Desmophen 1110 BD:

Linear polypropylene ether polyol, Covestro Deutschland AG

| OH number | 112 | mg KOH/g |
|---|---|---|
| OH functionality | 2.0 | |
| Acid number | ≤0.1 | mg KOH/g |
| Polydispersity | 1.1 | |
| Viscosity (25° C.) | 140 | mPas |

### NCO-Terminated Prepolymers:

### Example 1 (Inventive)

1640 g of hexamethylene diisocyanate (HDI) was heated to a temperature of 100° C. under nitrogen. 382 g of the polyesterpolyol 1 with a functionality of 2.7, Mn of 988 g/mol, was preheated to 80° C. and then added over 2 hours to the mixture via a dropping funnel. The mixture was stirred for a further 2 hours till the NCO content indicated the complete conversion. Subsequently, excess HDI was removed via thin-film evaporation at a temperature of 115° C. and a pressure of 0.06 mbar. The product obtained was a slightly yellow, clear NCO terminated prepolymer having the following analytical characteristics:

A content of 17% by weight of oligomers having a number average molecular weight ≤1000 g/mol, based on the total solid content of the NCO-terminated prepolymer.

| Mn | 1700 | g/mol |
|---|---|---|
| NCO content | 10.8% | |
| Polydispersity | 2.0 | |
| Viscosity (80° C.) | 88 00 | mPas |

| | |
|---|---|
| Residual Monomer | 0.16% |

The prepolymer was dissolved in 30% Methoxy propyl acetate (MPA).

### Example 2 (Inventive)

750 g of polyesterpolyol 1 with functionality of 2.7 and Mn of 988 g/mol was purified by thin film evaporation at 195° C. and a pressure of 0.07 mbar.

1630 g of hexamethylene diisocyanate (HDI) was heated to a temperature of 100° C. under nitrogen. 442 g of the pre-distilled polyesterpolyol 1 (Mn of 1110 g/mol) was preheated to 80° C. and then added over 4 hours to the mixture via a dropping funnel. The mixture was stirred for a further 2 hours till the NCO content was indicative of a complete conversion. Subsequently, excess HDI was removed via thin-film evaporation at a temperature of 115° C. and a pressure of 0.02 mbar. The product obtained was a slightly yellow, clear NCO terminated prepolymer having the following analytical characteristics:

A content of 3% by weight of oligomers having a number average molecular weight ≤1000 g/mol, based on the total solid content of the NCO-terminated prepolymer.

| Mn | 2700 | g/mol |
|---|---|---|
| NCO content | 9.2% | |
| Polydispersity | 2.6 | |
| Viscosity (80° C.) | 421 00 | mPas |

| | |
|---|---|
| Residual Monomer | 0.06% |

The prepolymer was dissolved in 35% Methoxy propyl acetate (MPA).

### Example 3 (Inventive)

750 g of polyesterpolyol 1 with functionality of 2.7 and Mn of 988 g/mol was purified by thin film evaporation at 195° C. and a pressure of 0.07 mbar.

1580 g of isophorone diisocyanate (IPDI) was heated to a temperature of 100° C. under nitrogen. 390 g of the pre-distilled polyesterpolyol 1 (Mn of 1110 g/mol) was preheated to 80° C. and then added over 6 hours to the mixture via a dropping funnel. The mixture was stirred for a further 1 hour till the NCO content was indicative of a complete conversion. Subsequently, excess IPDI was removed via thin-film evaporation at a temperature of 180° C. and a pressure of 0.02 mbar. The product obtained was a yellow, clear NCO terminated prepolymer having the following analytical characteristics:

A content of 3% by weight of oligomers having a number average molecular weight ≤1000 g/mol, based on the total solid content of the NCO-terminated prepolymer.

| Mn | 3100 | g/mol |
|---|---|---|
| NCO content | 7.6% | |
| Polydispersity | 3.3 | |
| Viscosity in 35% EA (23° C.) | 980 | mPas |

| | |
|---|---|
| Residual Monomer | 0.24% |

The prepolymer was dissolved in 35% Ethylacetate (EA).

### Example 4 (Comparative)

920 g of isophorone diisocyanate (IPDI) was heated to a temperature of 100° C. under nitrogen. 600 g of the polyetherpolyol Desmophen 1110 BD (Mn of 1002 g/mol) was added over 6 hours to the mixture via a dropping funnel. The mixture was stirred till the NCO content was indicative of a complete conversion. Subsequently, excess IPDI was removed via thin-film evaporation at a temperature of 180° C. and a pressure of 0.02 mbar. The product obtained was a yellow, clear NCO terminated prepolymer having the following analytical characteristics:

A content of 1.6% by weight of oligomers having a number average molecular weight ≤1000 g/mol, based on the total solid content of the NCO-terminated prepolymer.

| Mn | 2073 | g/mol |
|---|---|---|
| NCO content | 4.9% | |
| Polydispersity | 1.28 | |
| Viscosity (23° C.) | 12300 | mPas |

| | |
|---|---|
| Residual Monomer | 0.05% |

### Example 5 (Comparative)

300 g of hexamethylene diisocyanate (HDI) was heated to a temperature of 100° C. under nitrogen. 277 g of the polyetherpolyol Desmophen 1110 BD (Mn of 1002 g/mol) was added over 6 hours to the mixture via a dropping funnel. The mixture was stirred till the NCO content was indicative of a complete conversion. Subsequently, excess HDI was removed via thin-film evaporation at a temperature of 115° C. and a pressure of 0.03 mbar. The product obtained was a colorless, clear NCO terminated prepolymer having the following analytical characteristics:

A content of 1.0% by weight of oligomers having a number average molecular weight ≤1000 g/mol, based on the total solid content of the NCO-terminated prepolymer.

| Mn | 2772 | g/mol |
|---|---|---|
| NCO content | 4.4% | |
| Polydispersity | 1.43 | |
| Viscosity (23° C.) | 2080 | mPas |

| | |
|---|---|
| Residual Monomer | 0.02% |

### Example 6 (Comparative, According to WO2016/116376, Example 2)

1260 g of hexamethylene diisocyanate (HDI) was introduced under dry nitrogen with stirring at a temperature of 100° C. and 215 g of polyesterpolyol 2 was added over the course of 90 minutes. After the addition had ended, the reaction mixture was stirred further at 110° C. until, after about 3 hours, the NCO content of 39.8%, corresponding to complete urethanization, had been attained.

The unconverted monomeric HDI was removed on a thin-film evaporator at a temperature of 130° C. and a pressure of 0.1 mbar. This gave 382 g of a colorless clear prepolymer which had the following characteristics:

A content of 28.0% by weight of oligomers having a number average molecular weight ≤1000 g/mol, based on the total solid content of the NCO-terminated prepolymer.

| Mn | 1163 | g/mol |
|---|---|---|
| NCO content | 10.7% | |
| Polydispersity | 1.5 | |
| Viscosity (23° C.) | 3220 | mPas |

| | |
|---|---|
| Residual Monomer | 0.03% |

### Example 7 (Comparative, According to WO2016/116376, Example 3)

1260 g of hexamethylene diisocyanate (HDI) was introduced under dry nitrogen with stirring at a temperature of 100° C. and 325 g of polyesterpolyol 3 was added over the course of 90 minutes. After the addition had ended, the reaction mixture was stirred further at 110° C. until, after about 3 hours, the NCO content of 37.1%, corresponding to complete urethanization, had been attained.

The unconverted monomeric HDI was removed on a thin-film evaporator at a temperature of 130° C. and a pressure of 0.1 mbar. This gave 480 g of an initially colorless clear prepolymer which turned hazy and solidified after a few hours at room temperature. The semicrystalline product had the following characteristics:

A content of 7.1% by weight of oligomers having a number average molecular weight ≤1000 g/mol, based on the total solid content of the NCO-terminated prepolymer.

| Mn | 1599 | g/mol |
|---|---|---|
| NCO content | 8.3% | |
| Polydispersity | 1.2 | |
| Viscosity (23° C.) | 1810 | mPas |

| | |
|---|---|
| Residual Monomer | 0.02% |

### Application Testing:

BYK 310 silicone containing surface additive from BYK-Chemie GmbH, Germany
Dibutyltin dilaurate (DBTL), ADDOCAT® 201, Lanxess Deutschland GmbH, Germany
Setalux® D A 665 BA acrylic polyol, OH content 4.6%, Allnex, Germany
Desmophen® 650 MPA branched, hydroxyl-bearing polyester, OH content 5.3%, Covestro Deutschland AG, Germany
Desmophen® 2488 branched polyester polyol, OH content 16%, Covestro Deutschland AG, Germany
Setalux® D A 870 acrylic polyol, OH content 4.2%, Allnex, Germany
1-methoxypropyl-2-acetate (MPA), anhydrous, was obtained from Azelis, Germany toluene was obtained from Azelis, Germany.

### Component A:

The listed polyol is combined with Byk 310 0.1% and catalyst DBTL 0.03% and diluted with MPA.

### Component B:

The NCO terminated prepolymer of the Examples 1 to 7.

Formulation: Component A and B are combined in a ratio of 1:1 to give a final solid content of 50%. This mixture is stirred by hand and then applied to the substrate. For glass plate application, the formulation is applied using a coating knife. The dry coating thickness is approximately 50 μm. The coatings are then cured for 30 minutes at 60° C. Coated glass plates are used for chemical tests and pendulum hardness experiments. A visual observation of the coating is also noted.

Pendulum hardness: The pendulum damping according to König was determined to DIN EN ISO 1522:2007-04 on glass plates and is given in seconds in table 1.

To test the coatings for solvent resistance, small amounts of each of the solvents xylene, 1-methoxypropyl-2-acetate, ethyl acetate and acetone were placed in test tubes and provided with a cottonwool pad at the opening, thus forming a solvent-saturated atmosphere within the test tubes. The test tubes were subsequently brought with the cotton pad onto the surface of the coating on a glass plate, where they remained for 1 or 5 minutes. After the solvent had been wiped off, the film was examined for destruction/softening/loss of adhesion and rated (0: no change, 5: film completely dissolved). The 5 evaluations reported in table 1 are those for the four solvents in the order in each case of xylene (Xy), 1-methoxypropyl-2-acetate (MPA), ethyl acetate (EA) and acetone (Ac) in the form of four successive digits. These were determined according to DIN EN ISO 4628-1:2016-07.

TABLE 1
Overview of the coating formulations and the measured properties

| Application | Prepolymer of | | Pendulum | Chemical | |
|---|---|---|---|---|---|
| testing | Example no. | Polyol | Hardness | resistance | |
| Examples | (component B) | (component A) | (after 7 days) | (after 7 days) | Appearance |
| 1a | 1 | Setalux ® D A | 164 s | 1144 | Good |
| | | 665 BA | | | appearance |
| 1b | 1 | Desmophen ® | 200 s | 1124 | Good |
| | | 650 | | | appearance |
| 2a | 2 | Desmophen ® | 88 s | 1244 | Good |
| | | 2488 | | | appearance |
| 2b | 2 | Setalux ® D A | 193 s | 1144 | Good |
| | | 870 | | | appearance |
| 3a | 3 | Desmophen ® | 135 s | 0234 | Good |
| | | 650 | | | appearance |
| 4a | 4 | Desmophen ® | <15 s | Not measurable | Gummy, no |
| (comparative) | | 650 | | | hardness |
| 4b | 4 | Setalux ® D A | <15 s | Not measurable | Gummy, no |
| (comparative) | | 665 | | | hardness |
| 4c | 4 | Setalux ® D A | <15 s | Not measurable | Gummy, no |
| (comparative) | | 870 | | | hardness |
| 5a | 5 | Desmophen ® | <15 s | Not measurable | Gummy, no |
| (comparative) | | 650 | | | hardness |
| 5b | 5 | Setalux ® D A | <15 s | Not measurable | Gummy, no |
| (comparative) | | 665 | | | hardness |
| 5c | 5 | Setalux ® D A | <15 s | Not measurable | Gummy, no |
| (comparative) | | 870 | | | hardness |
| 6a | 6 | Setalux ® DA | <15 s | 2234* | Gummy |
| (comparative) | | 665 | | | |
| 6b | 6 | Desmophen ® | 42 s | 2224* | Gummy |
| (comparative) | | 650 | | | |
| 7a | 7 | Setalux ® D A | 28 s | 2224* | Gummy |
| (comparative) | | 665 | | | |
| 7b | 7 | Desmophen ® | 28 s | 2234* | Gummy |
| (comparative) | | 650 | | | |

*For these examples, after 5 minutes the film completely dissolved, thus the given values are determined after 1 minute testing.

### Discussion of the Results in Table 1:

As can be seen from the results, the inventive NCO-terminated prepolymers allows to obtain coating from formulations with commercially available standard polyols. On the contrary, the comparative formulations do not dry and lead to gummy and soft coatings with insufficient hardness and limited solvent resistance.

1. A NCO-terminated prepolymer for coating applications having a general formula (I), 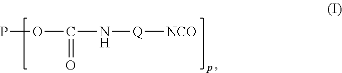
wherein P, Q and p are defined as follows
P each independently at least one organic radical obtained by removing the hydroxyl groups from a polyol unit,
Q each independently at least one organic radical obtained by removing the isocyanate groups from a monomeric diisocyanate unit and/or at least one organic radical obtained by removing the isocyanate groups from an uretdione unit having two isocyanate groups and
p each independently a number of ≥2.0, and
wherein the NCO-terminated prepolymer has
a NCO content of ≥6.5 to ≤12.0% by weight, based on total solid content of the NCO-terminated prepolymer, and
a content of ≤17% by weight of oligomers having a number average molecular weight ≤1000 g/mol, based on the total solid content of the NCO-terminated prepolymer, and
a monomeric diisocyanate content of <0.5% by weight, based on the total solid content of the NCO-terminated prepolymer and
a polydispersity of ≥2.0.

2. The NCO-terminated prepolymer according to claim 1, wherein the content of oligomers having a number average molecular weight ≤1000 g/mol is ≥0.5 to ≤17% by weight based on the total solid content of the NCO-terminated prepolymer.

3. The NCO-terminated prepolymer according to claim 1, wherein the NCO terminated prepolymer has an NCO content of ≥7.5 to ≤11.0% by weight.

4. The NCO-terminated prepolymer according to claim 1, wherein the NCO-terminated prepolymer has a number average molecular weight Mn≥1700 g/mol.

5. The NCO-terminated prepolymer according to claim 1, wherein the NCO-terminated prepolymer has an average NCO functionality of >2.0.

6. The NCO-terminated prepolymer according to claim 1, wherein Q in general formula (I) is each independently at least one an aliphatic and/or cycloaliphatic radical obtained by removing the isocyanate groups from a diisocyanate, preferably selected from the group consisting of 1,5-diisocyanatopentane, 1,6-diisocyanatohexane, isophorone diisocyanate, 2,4′- and 4,4′-diisocyanatodicyclohexylmethane 1,3- and 1,4-bis-isocyanatomethylcyclohexane, 1,3- and 1,4-xylylene diisocyanate and mixtures selected from the beforementioned.

7. The NCO-terminated prepolymer according to claim 1, wherein P in general formula (I) is each independently at least one polyol unit having an average molecular weight of ≥800 g/mol to ≤3000 g/mol and a OH-functionality of >2 to ≤3.

8. The NCO-terminated prepolymer according to claim 1, wherein p in general formula (I) is each independently a number of ≥2 to <4.5.

9. A process for preparing a NCO-terminated prepolymer according to claim 1, comprising the following steps
a) addition of at least one polyol having an hydroxyl group functionality of ≥2 to <3 and a polydispersity of ≥1.5 to a heated excess of at least one monomeric diisocyanate and/or at least one uretdione having two isocyanate groups in a ratio of NCO:OH groups 4:1 to 20:1 to form urethane groups,
b) removal of the excess of the monomeric diisocyanate is removed by distillation down to <0.5% by weight based on the total solid content of the NCO-terminated prepolymer, to obtain the NCO-terminated prepolymer, and
c) optionally addition of at least one solvent inert towards isocyanate groups.

10. The process according to claim 9, wherein the at least one polyol has an average molecular weight of ≥800 to ≤3000 g/mol.

11. A method of preparing curable compositions for coatings, adhesives and/or sealants comprising providing the NCO-terminated prepolymer according to claim 1.

12. A two-component-system, comprising a component A), comprising at least one NCO-terminated prepolymer according to claim 1, and a component B), comprising at least one compound which comprises at least one Zerewitinoff-active group.

13. The two-component-system according to claim 12, wherein said component B) comprises less than 5% by weight of organic solvent.

14. A process for curing a composition on a substrate, comprising the following steps
i) applying on at least one substrate at least one two-component-system according to claim 12; and
ii) exposing the deposited composition to a temperature of 0 to 120° C. to cure said deposited curing composition.

15. A cured article, obtainable or obtained by the process according to claim 14.
